(19) United States
(12) Patent Application Publication
(10) Pub. No.: US 2004/0167820 A1
(43) Pub. Date: Aug. 26, 2004

(54) Two part payment terminal

(76) Inventors: Diana Melick, Ronkonkoma, NY (US); Gerard J. Tarrant JR., Cieshire, CT (US); Thomas K. Roslak, Eastport, NY (US); Bruce A. Willins, East Northport, NY (US); Richard M. Vollkommer, Smithtown, NY (US); Amy Wang, Hauppauge, NY (US)

Correspondence Address: Himanshu S. Amin, Amin & Turocy, LLP, National City Center, 1900 E. 9th Street, 24th Floor, Cleveland, OH, 44114, US

(21) Appl. No.: 10/375,823

(22) Filed: Feb. 26, 2003

(51) Int. Cl. G06F 17/60

(52) U.S. Cl. 705/16

(57) ABSTRACT

The two part payment terminal system improves communication between a server and one or more customers. The system includes a mobile terminal that can be hand-held and employed by a server for taking orders, such as in a restaurant. The system can also include a plurality of mobile companion devices that can be employed by customers for payment of the ordered items. Customers and/or servers can also utilize the mobile terminal and/or companion devices to provide the customer with menu items, available discounts, nutritional information, etc.

### TECHNICAL FIELD

The present invention generally relates to a payment terminal system. In particular, the present invention relates to systems and methods for a handheld terminal for table side ordering and a mobile companion.

### BACKGROUND OF THE INVENTION

Restaurants, especially high volume restaurants and restaurant chains typically employ computers, or terminals, to process customer orders. The terminals are placed at service stations of the restaurants. Some restaurants have two or more of terminals depending on the size of the establishment. The servers can log on by entering a numeric code or by swiping a magnetic card assigned to them. After taking the orders at the customer tables using a paper pad, the server enters the orders in to the computer terminals, and the terminals send the orders to appropriate stations in the kitchen. The same terminals are used to print the customers' checks, swipe credit cards for payment, and to print receipts.

Despite the sophistication and reliability of the computer terminals, only one person can use a terminal at a time. Not having enough terminals to send in the orders on time is a constant problem especially in high volume restaurants.

Servers serving large parties or separating tickets for large parties often occupy the terminals for a long period of time, thereby disabling others use of the terminals. Moreover, too many users using the terminals in a short period of time can easily overload the system resulting a system crash. In that case the entire computer system in the restaurant must be turned off and restarted.

Other servers waiting to send their orders or waiting for the system to restart can easily be sidetracked, orders can be late or missed. Late or missed orders cost the restaurant industry millions of dollars each year.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides systems and methods for a two part payment terminal system. The two part payment terminal system improves communication between a server and one or more customers. The system includes a mobile terminal that can be hand-held and employed by a server for taking orders, such as in a restaurant. The mobile terminal can also be utilized to provide the customer with menu items, available discounts, nutritional information, etc. The system can also include a mobile companion device that can be employed by customers for payment of the ordered items. Accordingly, the mobile companion device can include a printer for printing a customer receipt.

In particular, the handheld terminal can employ at least one real time location tracking system (e.g., triangulation, RFID, reading a barcode having location information encoded therein). The real time location tracking system allows a server to take a customer's order without having to enter a table number. The handheld terminal is coupled to one or more mobile companions via a wireless network. The mobile companion(s) can also be located via a real time location tracking system. Moreover, the handheld terminal and/or mobile companion(s) can include an alarm to indicate whether the handheld terminal and/or mobile companion(s) is outside a predetermined zone.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of a two part payment terminal system in accordance with an aspect of the present invention.

FIG. 2 illustrates a perspective front view of a handheld terminal in accordance with an aspect of the present invention.

FIG. 3 illustrates a perspective front view of an external printer in accordance with an aspect of the present invention.

FIG. 4 illustrates an example of a mobile companion in accordance with an aspect of the present invention.

FIG. 5 illustrates an example of a receipt in accordance with an aspect of the present invention.

FIG. 6 illustrates another example of a mobile companion in accordance with an aspect of the present invention.

FIG. 7 illustrates an example of a three part payment terminal system in accordance with an aspect of the present invention.

FIG. 8 illustrates an example of a two part payment terminal system in accordance with an aspect of the present invention.

FIG. 9 illustrates an example of a three part payment terminal system in accordance with an aspect of the present invention.

FIG. 10 illustrates an example of a one part payment terminal system in accordance with an aspect of the present invention.

FIG. 11 illustrates an exemplary environment for employing a two part payment terminal system in accordance with an aspect of the present invention.

FIG. 12 illustrates a security system in accordance with an aspect of the present invention.

FIG. 13 illustrates a schematic block diagram of a handheld terminal and/or mobile companion in accordance with an aspect of the present invention.

FIG. 14 illustrates a methodology for fabricating a handheld terminal and mobile companion in accordance with an aspect of the present invention.

### DETAILED DESCRIPTION OF THE INVENTION

The present invention relates to systems and methods for a two part payment terminal. The present invention will now be described with reference to the drawings, wherein like reference numerals are used to refer to like elements throughout. It is to be appreciated that the various drawings are not drawn to scale from one figure to another nor inside a given figure, and in particular that the size of the components are arbitrarily drawn for facilitating the reading of the drawings. In the following description, for purposes of explanation, numerous specific details are set forth in order to provide a thorough understanding of the present invention. It may be evident, however, that the present invention may be practiced without these specific details. In other instances, well-known structures and devices are shown in block form in order to facilitate describing the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. For example, it is to be appreciated that certain aspects of the invention can employ inference engines (e.g., classifiers trained explicitly and/or implicitly) to perform a probabilistic-based or statistical-based analysis as to inferring a user's goals or intentions in connection with the two part payment system described herein. Thus, a handheld terminal and/or mobile companion can infer a menu item and/or payment method potentially desired by a customer based on historical, extrinsic and state information, and perform an action related to the item (e.g., to facilitate sale thereof). Explicit training can be performed on a classifier prior to customer use, and implicit training can be an on-going training process performed by a user/customer, for example.

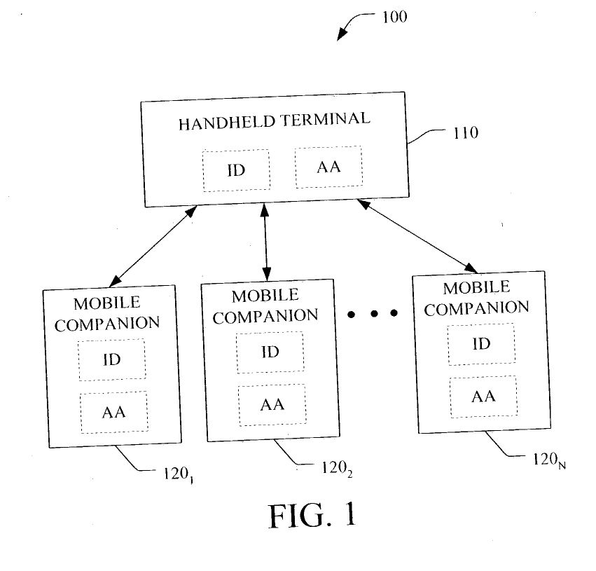

Referring initially to FIG. 1, a schematic block diagram of a two part payment terminal system 100 is depicted. The two part payment terminal system 100 includes a handheld terminal 110, which can be employed by a server and/or customer for table side ordering at a restaurant. For example, a server can enter a customer's order into the handheld terminal 110 via a touch screen or other user input device. The server can then employ the handheld terminal 110 to transmit the order to a kitchen or order prep area of the restaurant.

The handheld terminal 110 can interact with one or more mobile companions, 120₁ through 120_{N}, N being an integer greater than or equal to one. The mobile companion(s), 120₁ through 120_{N} can be referred to collectively as mobile companion(s) 120. The mobile companion(s) 120 can be located at one or more tables in the restaurant to facilitate customer payment. The handheld terminal 110 and mobile companion(s) 120 can communicate via a plurality of methods. For example, the handheld terminal 110 and mobile companion(s) 120 can connect to each other physically, via a cable and/or mating parts. Additionally, or alternatively, the handheld terminal 110 and mobile companion(s) 120 can communicate via a wireless network, such as a WAN or LAN. It is to be appreciated that any suitable communication protocol can be employed. For example, the network can employ Bluetooth, Ethernet (IEEE 802.3), Wireless Ethernet (IEEE 802.11), PPP (point-to-point protocol), point-to-multipoint short-range RF (Radio Frequency), WAP (Wireless Application Protocol), IP, lPv6, TCP and User Datagram Protocol (UDP). The server can transmit an itemized bill and payment amount from the handheld terminal 110 to a mobile companion 120. The customer can view the bill and payment amount on a display of the mobile companion 120. Alternatively, or additionally, the bill and payment amount can print directly from a printer in the mobile companion 120. A user input device on the handheld terminal 110 or mobile companion 120, such as a magnetic stripe reader, can be employed to make a payment. When the payment has been completed, the mobile companion 120 can transmit a message to the handheld terminal 110 to notify the server.

The handheld terminal 110 and mobile companion(s) 120 can optionally include identification components (ID), which provide the handheld terminal 110 and mobile companion(s) 120 with unique IDs. At least one of the handheld terminal 110 and mobile companion(s) 120 can also include an auto association component (AA) that associates a handheld terminal 110 with at least one mobile companion 120. Accordingly, when a mobile companion(s) 120 is coupled to a handheld terminal 110, the mobile companion(s) 120 and/or the handheld terminal 110 serially sends its unique ID information to the handheld terminal 110 and/or mobile companion(s) 120, respectively. The ID information is employed by the handheld terminal 110 and/or mobile companion(s) 120 to automatically associate itself with the mobile companion(s) 110 and/or handheld terminal 120. The association can be exclusive or the handheld terminal 110 and mobile companion(s) 120 can have a plurality of associations. The auto association component (AA) facilitates dynamic reconfiguration of the handheld terminal 110 and mobile companion(s) 120, and/or vice versa; and thus, mitigates the need for manually setting an association between the handheld terminal 110 and mobile companion(s) 120.

The handheld terminal 110 and/or mobile companion 120 can employ at least one real time location tracking system. The real time location tracking system allows a server to take a customer's order without having to enter a table number. For example, the handheld terminal 110 and/or mobile companion 120 can employ a network based real time location tracking technique, such as triangulation. To determine a location of the handheld terminal 110 and/or mobile companion 120 using triangulation principles, at least three detectors should be able to detect a signal transmitted from a signal source and record the times-of-arrival at each of the detectors. Alternately, to determine a handheld terminal's location, one detector should be able to detect a signal transmitted from at least three signal sources and record the times-of-arrival of each signal at the detector. The real time location tracking system can be based on an IEEE 802.11 WLAN signal or any other suitable signal.

Another location system that can be employed by the present invention is a radio frequency identification (RFID) location system. RFID systems can be used to identify and locate a table in a restaurant, for example, by reading information stored on tags or hidden labels on the table and/or floor. Such systems do not merely detect the presence or non-presence of a tag. Instead, these systems can be used to remotely identify the physical objects by a response signal sent back by the tag.

An RFID system typically employs at least two components, a “transponder” or “tag,” which is attached to the physical item to be identified, and a “reader,” which sends an electromagnetic signal to the transponder and then detects a response. Typically, the reader emits a RF signal, which is received by the transponder, after the transponder comes within an appropriate range. In response, the transponder sends its information via a modulated RF signal back to the reader. The reader detects this modulated signal, and can identify the transponder by decoding the modulated signal. After identifying the transponder, the reader can either store the decoded information or transmit the decoded signal to a computer.

The transponder can be either “passive” or “active.” A passive transponder is generally a simple resonant circuit, consisting of an inductive coil and a capacitor. Passive transponders are generally powered by the carrier signal transmitted from the reader. Active transponders, on the other hand, require their own battery source.

Yet, another location system that can be employed by the present invention is a bar code location tracking system. A table and/or a portion of a floor in a restaurant can include a bar code, which contains location information about where the table and/or floor portion is with respect to the restaurant. A bar code reader in the handheld terminal 110 and/or mobile companion 120 can be employed to read the bar code and determine a location of a customer.

It is to be appreciated that any other location tracking system can be employed and is contemplated as falling within the scope of the present invention.

FIG. 2 illustrates an example of a handheld terminal 200 in accordance with an aspect of the present invention. The handheld terminal 200 includes a housing 210 which can be constructed from a high strength plastic, metal, or any other suitable material and is rugged enough to withstand a drop by a server. Moreover, the handheld terminal 200 can include a protective guard 215 around a portion of the housing 210 to protect the terminal 200 in the event of a drop. The handheld terminal 200 includes a display 220. As is conventional, the display 220 functions to display data or other information relating to ordinary operation of the handheld terminal 200 and/or mobile companion (not shown). For example, software operating on the handheld terminal 200 and/or mobile companion may provide for the display of restaurant information, menu information, specials, price information, etc. to a user. Additionally, the display 220 may display a variety of functions that are executable by the handheld terminal 200 and/or one or more mobile companions. The display 220 provides for graphics based alpha-numerical information such as, for example, the price of a menu item. The display 220 also provides for the display of graphics such as icons representative of particular menu items, for example. The display 220 can also be a touch screen, which may employ capacitive, resistive touch, infrared, surface acoustic wave, or grounded acoustic wave technology.

The handheld terminal 200 further includes user input keys 230, including a pin pad 232, for allowing a user to input information and/or operational commands. The user input keys 230 may include a full alphanumeric keypad, function keys, enter keys, etc. A privacy guard 235 can be disposed around at least a portion of the user input keys, such as the pin pad 232, to allow a customer to privately enter a personal identification number (PTN). The handheld terminal 200 can also include a magnetic stripe reader 240 and/or smart card reader (not shown) and/or scanner (not shown). The magnetic stripe reader 240 can receive credit card, bank card, etc. information as a customer payment option. An electronic signature apparatus (not shown) can also be employed in connection with the magnetic stripe reader or a telecheck system.

The handheld terminal 200 can also include a window (not shown) in which a bar code reader is able to read a bar code label, or the like, presented to the handheld terminal 200. The handheld terminal 200 can include a LED (not shown) that is illuminated to reflect whether the bar code has been properly or improperly read. Alternatively, or additionally, a sound may be emitted from a speaker (not shown) to alert the user that the bar code has been successfully imaged and decoded. The handheld terminal 200 also includes an antenna (not shown) for wireless communication with an RF access point; and an IR transceiver (not shown) for communication with an IR access point.

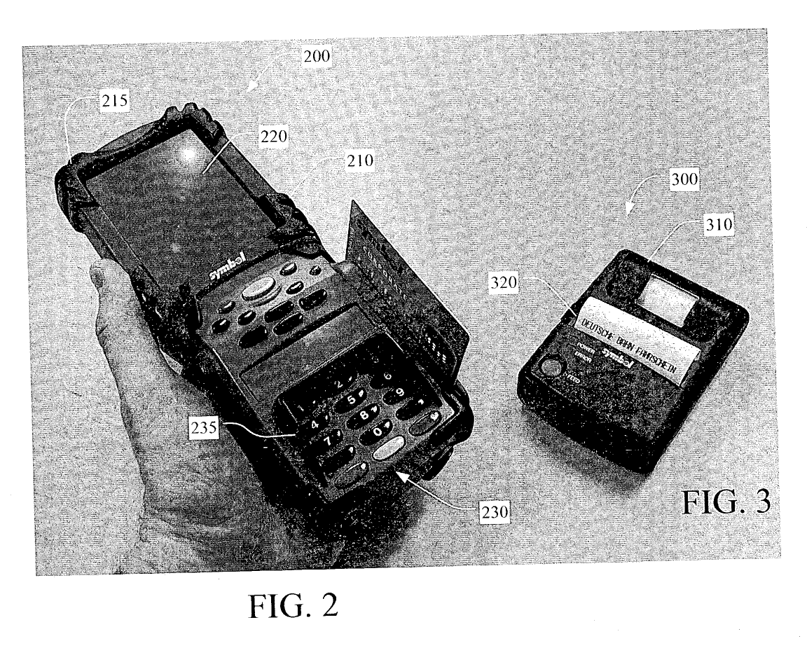

Turning now to FIG. 3, an example of an external printer 300 is depicted in accordance with an aspect of the present invention. The external printer 300 includes a housing 310 which can be constructed from a high strength plastic, metal, or any other suitable material. The external printer 300 functions to print out a paper receipt for the customer and/or restaurant. The external printer 300 can be a thermal printer which discharges the receipt through a slot shaped opening in an upright front surface of the housing 310. The thermal printer can includes a thermal printhead and an opposing platen to position the paper against the printhead. A motor drives a feed roller. The feed roller operates in conjunction with an idler roller to draw paper from a paper roll past the printhead and feed the receipt or recipe printout out of the slot shaped opening in the housing. Printer driver circuitry for operating the printer components is mounted on a control printed circuit board disposed in the housing. At least a portion of the circuitry is suitable embodied in code stored in a memory represented by a memory chip and executed by the processor, both on printed circuit board.

It should be appreciated that common printers could be placed at convenient locations within the store. The mobile companion would transmit data via the RF network to a chosen common printer. The common printer will typically be chosen based on the location of the terminal within the restaurant as determined by the location detection system.

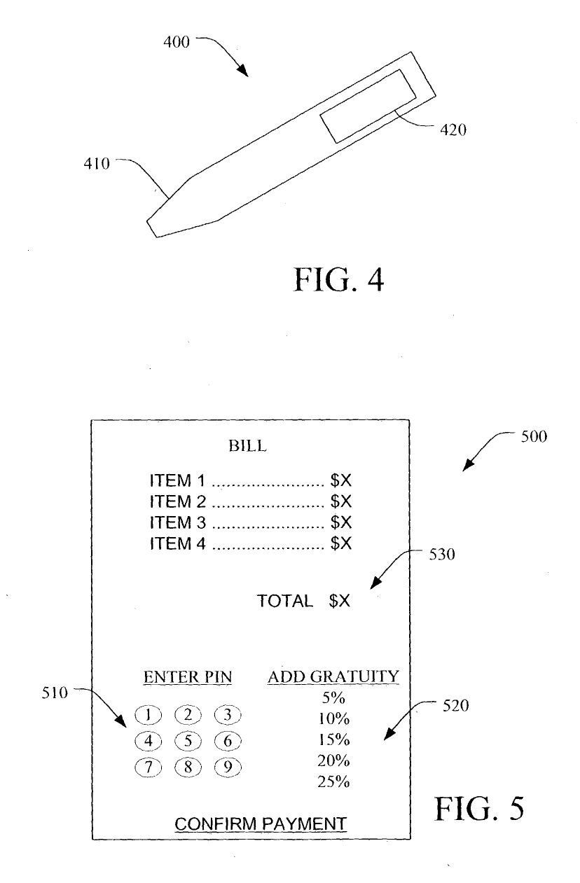

Turning now to FIG. 4, an example of a mobile companion 400 that can be employed in connection with a handheld terminal is illustrated. The mobile companion 400 includes a substantially pen-shaped housing 410. Within the pen-shaped housing 410 is a scanning and/or imaging device (not shown) that facilitates PIN entry from a receipt. For example, when a customer is presented with a bill 500 in a restaurant, the customer can employ the pen-shaped mobile companion 400 to approve a payment amount. A keypad 510 can be printed on a portion of the bill 500, as depicted in FIG. 5. The keypad 510 is printed in such a way that the mobile companion 400 can identify selected alphanumeric characters, such as via a scanner and/or imager, via inertial movement of the mobile companion, etc. The alphanumeric characters can comprise a plurality of bar codes and/or other identifying indicia to facilitate recognition by a scanner and/or imager. If inertial movement is employed to recognize selected alphanumeric characters, a reference point should be initially established. Inertial movement can also be employed if signature capture is desired.

Accordingly, the customer can utilize the printed keypad 510 in conjunction with the pen-shaped mobile companion 400 to enter a PIN number. Pre-calculated gratuity (e.g., in the form of percentages) 520 can also be printed on a portion of the receipt, such that the customer can select a gratuity amount to add to the bill 500 with the mobile companion 400. A total bill amount 530, including gratuity, and/or confirmation of the payment can be presented to the customer via a display 420 on the mobile companion 400, a speaker, or any other suitable method. Alternatively or additionally, the current bill 500 can be inserted into a printer and the printer can update the total bill amount based on the gratuity selected. The customer can also opt to print a second receipt with confirmation of the payment to a printer located at or near the customer's table or anywhere in the restaurant or to a handheld terminal carried by a server.

One or more mobile companions can be located and/or stored in a central repository and/or can reside with a server. Server can reconfigure the mobile companion(s) to correspond with a particular order/transaction. The mobile companion(s) can be reconfigured by associating the mobile companion(s) with a particular handheld terminal. The mobile companion(s) can also include writing mode, in which the mobile companion(s) can be employed as a conventional writing instrument.

It is to be appreciated that the functionalities associated with the pen-shaped mobile companion can be included in a mobile companion having any other desired shape. As another example, the pen-shaped mobile companion can be associated with a support structure (not shown), which includes many of the functionalities associated with the mobile companion, as well as additional functionalities, such as a magnetic stripe reader, smart card reader, a charging component, etc.

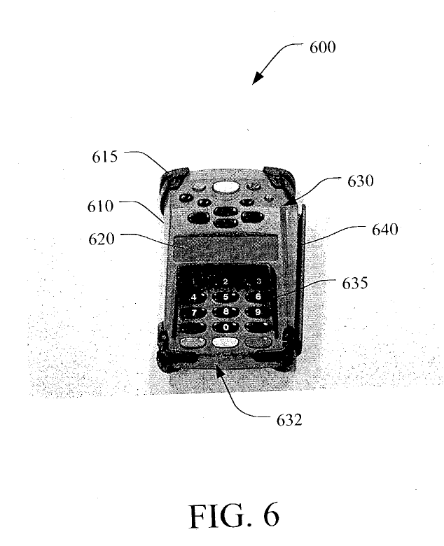

FIG. 6 illustrates yet another example of a mobile companion 600 in accordance with an aspect of the present invention. The mobile companion 600 includes a housing 610 which can be constructed from a high strength plastic, metal, or any other suitable material and is rugged enough to withstand a drop by a server and/or customer. Moreover, the mobile companion 600 can include a protective guard 615 around a portion of the housing 610 to protect the mobile companion 600 in the event of a drop. A display 620 is disposed within the housing to display data or other information relating to ordinary operation of the mobile companion 600 and/or a handheld terminal. For example, software operating on the mobile companion 600 may provide for the display of restaurant information, menu information, specials, price information, etc. to a user. Additionally, the display may display a variety of functions that are executable by the mobile companion 600 and/or handheld terminal. The display provides for graphics based alpha-numerical information such as, for example, the price of a menu item. The display also provides for the display of graphics such as icons representative of particular menu items, for example. The display can also be a touch screen, which may employ capacitive, resistive touch, infrared, surface acoustic wave, or grounded acoustic wave technology.

The mobile companion 600 can also include a plurality of input devices. For example, the mobile companion can include user input keys 630, including a pin pad 632, for allowing a user to input information and/or operational commands. The user input keys 630 may include a full alphanumeric keypad, function keys, enter keys, etc. A privacy guard 635 can be disposed around at least a portion of the user input keys, such as the pin pad 632, to allow a customer to privately enter a PIN. The mobile companion can also include a magnetic stripe reader 640 and/or smart card reader and/or scanner (not shown). The magnetic stripe reader 640 can receive credit card, bank card, etc. information as a customer payment option. An electronic signature apparatus (not shown) can also be employed in connection with the magnetic stripe reader 640 or a telecheck system. The mobile companion 600 can also include a key fob reader, and/or a biometric sensor, such as a thumbprint reader. Accordingly, a smart card, ID card, key fob, and/or a user's biometric data (e.g., iris pattern, fingerprint, facial features) can be employed to provide for storage and retrieval of a customer's personal information, demographic profile, and shopping transaction history data. Alternatively, or additionally, personal information can be provided via a user ID and password, which a customer enters into the mobile companion 600. Customer identification information can be employed to determine an award of incentive or loyalty points and/or whether the customer is eligible for any special discounts.

With respect to the mobile companion examples 300, 400, 600 described herein, the mobile companion 300, 400, 600 can further include an antenna (not shown) for wireless communication with an RF access point; and an IR transceiver (not shown) for communication with an IR access point. Thus, the mobile companion 300, 400, 600 can be located via at least one of the location tracking systems described herein. A table service alert function can be included in the mobile companion 300, 400, 600, such that a customer can page a server if service is needed. The page, along with the table location, will display in real-time on the server's handheld terminal. Similarly, the server can monitor a plurality of mobile companions 300, 400, 600 and/or tables in real time. For example, the handheld terminal can include a display option in which all of the mobile companions 300, 400, 600 that are associated with the terminal can indicate a status of the mobile companion 300, 400, 600 and/or table, such as location, time since last service, time since order placed, whether payment has been completed, etc. Further, if the mobile companion 300, 400, 600 is moved outside of a predetermined area, the mobile companion 300, 400, 600 can emit an alarm sound and/or transmit an alarm message to one or more handheld terminals and/or a host computer.

The handheld terminal and mobile companion can include mating electrical contacts (not shown). Moreover, the handheld terminal can include a docking station for at least one mobile companion. Accordingly, the mobile companion can be charged via a battery and/or power source of the handheld terminal without being plugged into an external power source. Alternatively, the mobile companion can include very limited battery power and can require the handheld terminal to extract charge for the battery. Moreover, the electrical contacts can be employed to auto associate the mobile companion with the handheld terminal.

As another alternative, the two part payment terminal system can employ inductive charging to charge a handheld terminal and/or mobile companion. Additionally, an inductive charging basket can be utilized at a central location of a restaurant for charging a plurality of handheld terminals and/or mobile companions.

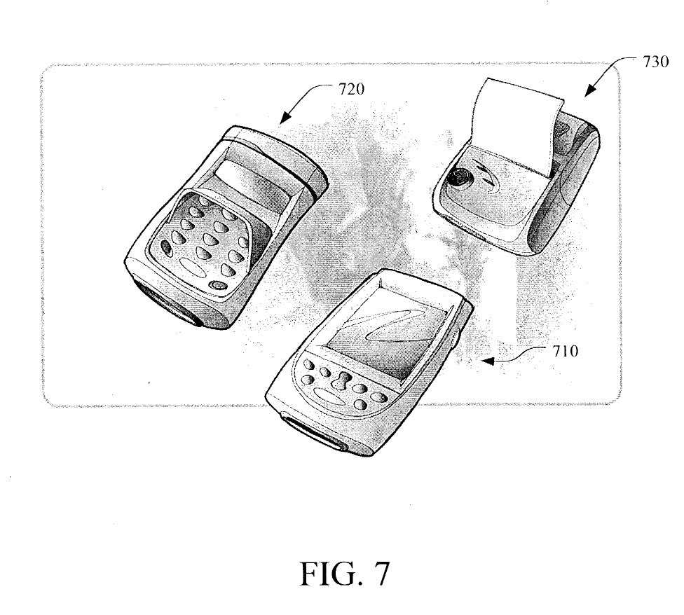

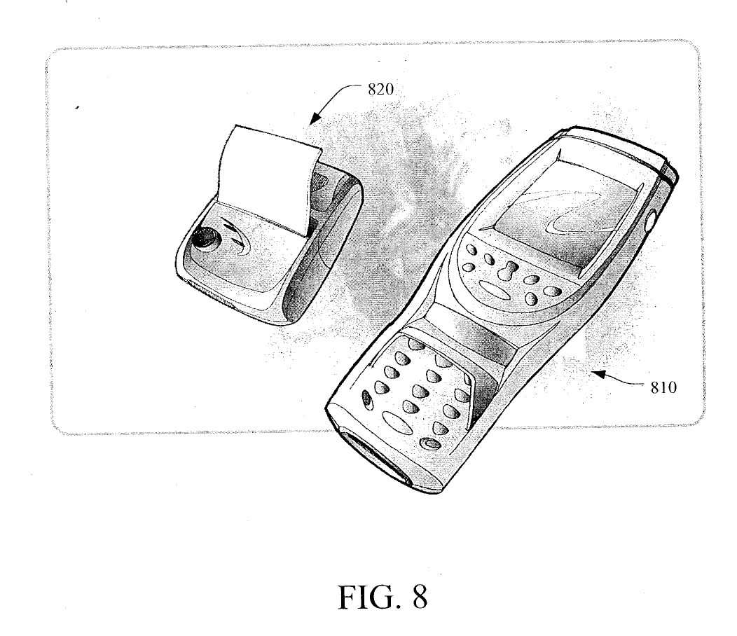

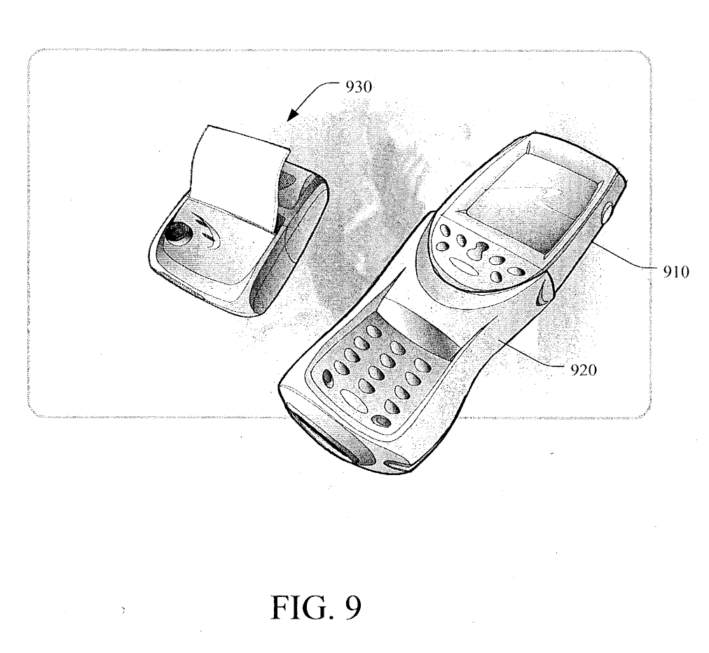

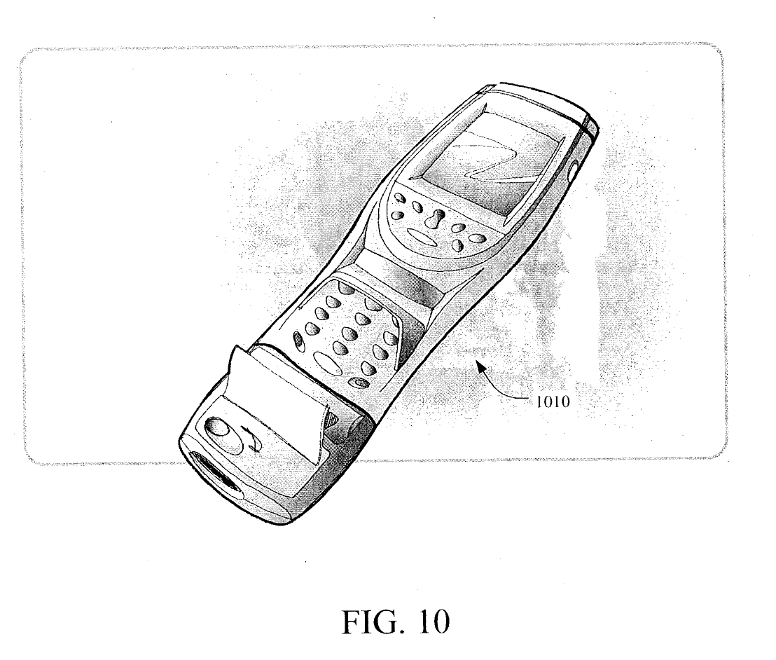

FIGS. 7-10 depict examples of payment terminal systems that can be employed in accordance with an aspect of the present invention. FIG. 7 illustrates a system with three components: a handheld terminal 710 for use by a server to provide customer services; a mobile companion 720 for use by a customer to pay for a transaction; and an external printer 730 to provide a receipt for the restaurant and/or customer. FIG. 8 illustrates a system with two components: a handheld terminal 810, which includes the functionalities of both handheld terminal 710 and mobile companion 720; and an external printer 820 to provide a receipt of the transaction. Turning now to FIG. 9, a system having three components is illustrated. A handheld terminal 910 employed for providing customer services is docked into a mobile companion 920 for processing payment transactions. Alternatively, a mobile companion can be docked into a handheld terminal. It is to be appreciated that when a first component is docked into a second component, the first component can function as an integral part of the second component. For example, when a mobile companion is docked into a handheld terminal, the handheld terminal can utilize the functions of the mobile companion. FIG. 10 illustrates a system in which the functionalities of a handheld terminal, mobile companion, and printer, as described herein, are combined into one portable terminal 1010.

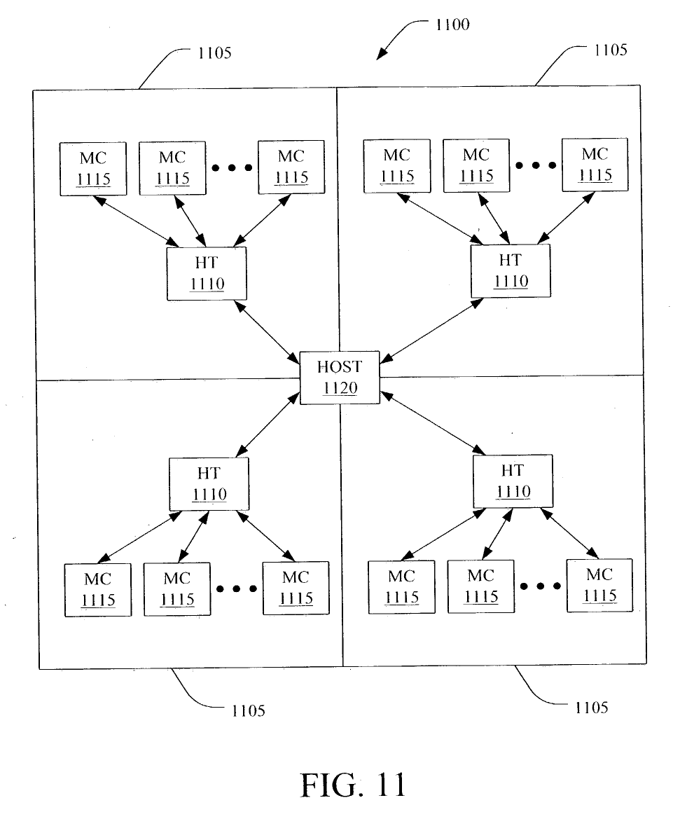

FIG. 11 illustrates a schematic block diagram of a restaurant 1100 employing a two part payment terminal system. The restaurant 1100 can be divided into a plurality of sections 1105. Four equal sections are shown in FIG. 11 for purposes of illustration only. The restaurant can include any number of sections of any size. For example, the restaurant may have only one section. Each section includes a handheld terminal 1110 and one or more mobile companions 1115. The mobile companion(s) 1115 can be associated with one or more tables located in the restaurant 1100. A server assigned to a particular section 1105 can utilize the handheld terminal 1110 to take an order from one or more customers. Upon taking the order, the server can transmit the order to a host computer 1120, which can transmit the order to a kitchen. Alternatively, the handheld terminal 1110 can transmit the order directly to the kitchen.

The host computer 1120 can monitor a status of the handheld terminals 1110. The host computer 1120 can monitor when each of the customers was last serviced. For example, if a customer was not asked for assistance within a predetermined time period (e.g, in the last 30 minutes), a message could be sent to the server's handheld terminal 1110 to check up on the customer(s). The host computer 1120 can also provide improved estimates for an amount of time for a next available table. The handheld terminals 1110 provide additional data that can be utilized to provide the improved estimates. The additional data can include: number of guests at a table, time orders were placed, time orders arrived at the table, type of food ordered, etc.

Although the host computer 1120 is depicted as communicating with the handheld terminals 1110; it is to be appreciated that the host computer 1120 may also communicate directly with the mobile companion(s) 1115 to monitor a status of the mobile companion(s) 1115.

The mobile companion(s) 1115 can be employed by the customer(s) to pay for the order. The two part payment terminal system can have an “express pay” feature. The customer(s) gives the server a credit card, or swipes the credit cart through a magnetic stripe reader on the mobile companion 1115, prior to completing the meal. When the customer(s) is finished with the meal, the customer(s) can simply leave. (Gratuity may be pre-approved as well.) Alternatively, or additionally, the two part payment terminal system can have an “easy pay” feature. The customer(s) can have a key fob or other device that identifies the customer and permits easy payment. The key fob (and similar devices, such as smartcards) provide two-factor authentication: the customer(s) has a personal identification number (PIN) for authentication; after the customer(s) correctly enters their PIN, the device displays a number which allows them to log onto the network. A message can be transmitted from the mobile companion 1115 to the handheld terminal 1110 indicating a status of the customer's payment. For example, if the customer is denied credit, the server—not the customer—is notified. After a customer makes a payment on the mobile companion 1115, a message is automatically transmitted to the handheld terminal 1110 and/or the host computer 1120 to have the table cleaned and setup for the next customer.

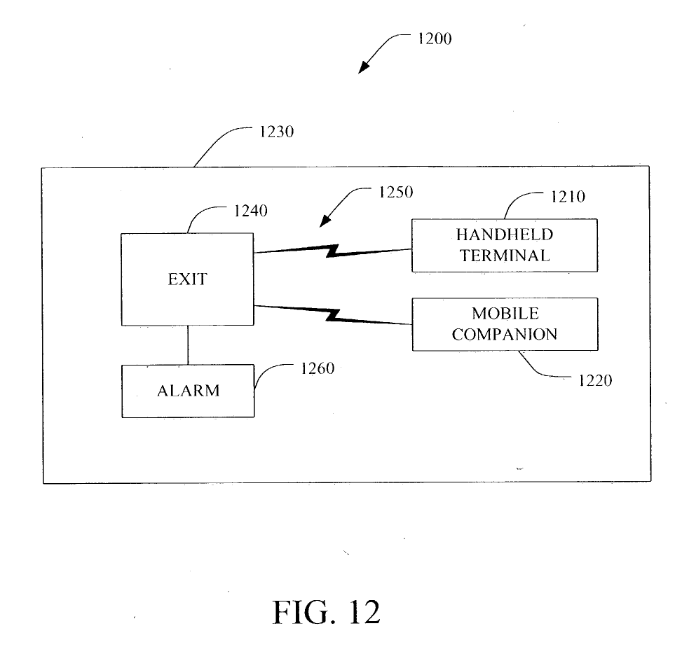

FIG. 12 depicts a security system 1200 in accordance with an aspect of the present invention. A handheld terminal 1210 and/or mobile companion 1220 located within a restaurant environment 1230 can be coupled to the security system 1200 to mitigate theft of the handheld terminal 1210 and/or mobile companion 1220. For example, a wireless system can be installed at or within a close proximity to at least one exit 1240 in the retail environment 1230. As the handheld terminal 1210 and/or mobile companion 1220 enter or come within close proximity of the wireless system, the wireless ID of the handheld terminal 1210 and/or mobile companion 1220 is interrogated via at least one communication channel 1250. The handheld terminal 1210 and/or mobile companion 1220 can communicate via a transceiver or communication can occur directly with at least one access point of the restaurant environment 1230. Upon detection of the wireless ID(s), the wireless ID(s) is compared to a database or list of known “in-store” devices. If the detected ID(s) matches an “in-store” device, an alarm 1260 will sound to provide notification that at least one handheld terminal 1210 and/or mobile companion 1220 is about to leave the restaurant environment 1230. If, on the other hand, the detected ID(s) does not match an “in-store” device listed in the database, the alarm 1260 will not be activated.

It is to be appreciated that any suitable communication protocol can be employed. For example, the network can employ Bluetooth, Ethernet (IEEE 802.3), Wireless Ethernet (IEEE 802.11), PPP (point-to-point protocol), point-to-multipoint short-range RF (Radio Frequency), WAP (Wireless Application Protocol), IP, IPv6, TCP and User Datagram Protocol (UDP). Further, the network connection can be via an extranet and/or a shared private network. For example, the network connection can be via a phone connection (not shown) from the handheld terminal 1210 and/or mobile companion 1220 to an Internet Service Provider (ISP) to the security system 1200. Another possible network connection is via a Local Area Network (LAN) to the security system 1200. It is noted that the handheld terminal 1210 and/or mobile companion 1220 can communicate over a separate and isolated network from the security system network. Information exchanged between and among the handheld terminal 1210 and/or mobile companion 1220 and the security system 1200 can be in a variety of formats and can include, but is not limited to, such technologies as HTML, SHTML, VB Script, JAVA, CGI Script, JAVA Script, dynamic HTML, PPP, RPC, TELNET, TCP/IP, FTP, ASP, XML, PDF, EDI, WML as well as other formats.

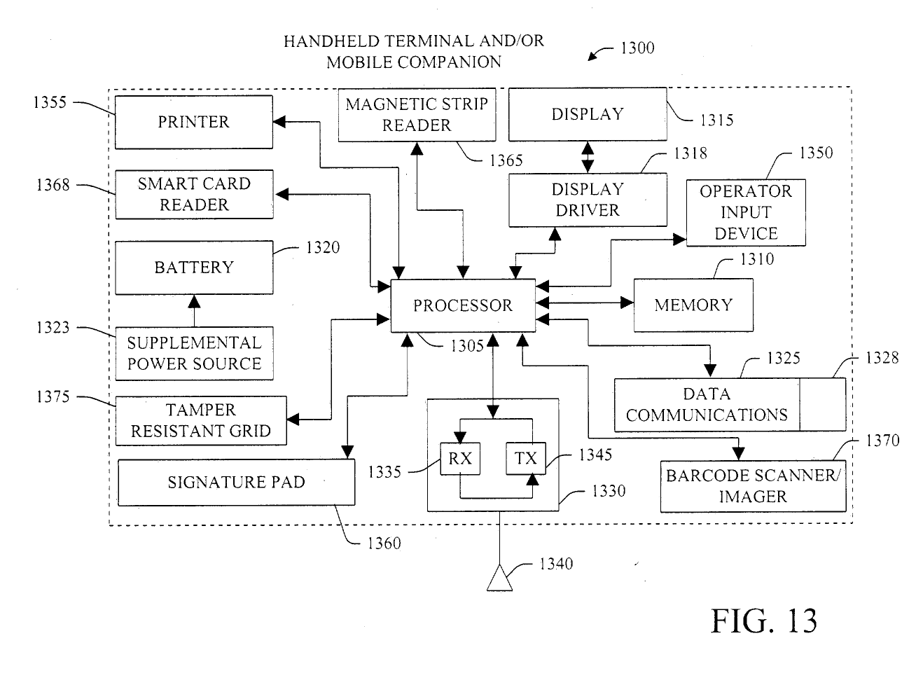

Turning now to FIG. 13, a schematic representation according to one aspect of the present invention is shown in which a processor 1305 is responsible for controlling the general operation of a handheld terminal and/or mobile companion 1300. The processor 1305 is programmed to control and operate the various components within the handheld terminal and/or mobile companion 1300 in order to carry out the various functions described herein. The processor or CPU 1305 can be any of a plurality of suitable processors. The manner in which the processor 1305 can be programmed to carry out the functions relating to the present invention will be readily apparent to those having ordinary skill in the art based on the description provided herein.

A memory 1310 tied to the processor 1305 is also included in the handheld terminal and/or mobile companion 1300 and serves to store program code executed by the processor 1305 for carrying out operating functions of the handheld terminal and/or mobile companion 1300 as described herein. The memory 1310 also serves as a storage medium for temporarily storing information such as receipt transaction information and the like. The memory 1310 is adapted to store a complete set of the information to be displayed. According to one aspect, the memory 1310 has sufficient capacity to store multiple sets of information, and the processor 1305 could include a program for alternating or cycling between various sets of display information.

A display 1315 is coupled to the processor 1305 via a display driver system 1318. The display 1315 may be a liquid crystal display (LCD) or the like. In this example, the display 1315 is a ¼ VGA display with 16 levels of gray scale. The display 1315 functions to display data or other information relating to ordinary operation of the handheld terminal and/or mobile companion 1300. For example, the display 1315 may display a set of customer information, which is displayed to the operator and may be transmitted over a system backbone (not shown). Additionally, the display 1315 may display a variety of functions that control the execution of the handheld terminal and/or mobile companion 1300. The display 1315 is capable of displaying both alphanumeric and graphical characters. Power is provided to the processor 1305 and other components forming the handheld terminal and/or mobile companion 1300 by at least one battery 1320. In the event that the battery(s) 1320 fails or becomes disconnected from handheld terminal and/or mobile companion 1300, a supplemental power source 1323 can be employed to provide power to the processor 1305. The handheld terminal and/or mobile companion 1300 may enter a minimum current draw of sleep mode upon detection of a battery failure.

The handheld terminal and/or mobile companion 1300 includes a communication subsystem 1325 that includes a data communication port 1328, which is employed to interface the processor 1305 with the main computer. The handheld terminal and/or mobile companion 1300 also optionally includes an RF section 1330 connected to the processor 1305. The RF section 1330 includes an RF receiver 1335, which receives RF transmissions from the main computer for example via an antenna 1340 and demodulates the signal to obtain digital information modulated therein. The RF section 1330 also includes an RF transmitter 1345 for transmitting information to the main computer, for example, in response to an operator input at a operator input device 1350 (e.g., keypad, pin pad, touchscreen) or the completion of a transaction. Peripheral devices, such as a printer 1355, signature pad 1360, magnetic stripe reader 1365, smart card reader 1368, and barcode scanner/imager 1370 can also be coupled to the handheld terminal and/or mobile companion 1300 through the processor 1305.

The handheld terminal and/or mobile companion 1300 also includes a tamper resistant grid 1375 to provide for secure payment transactions. If the handheld terminal and/or mobile companion 1300 is employed as payment terminal, it can be loaded with a special operating system. However, if the handheld terminal and/or mobile companion 1300 is employed as a general purpose terminal, it can be loaded with a general purpose operating system.

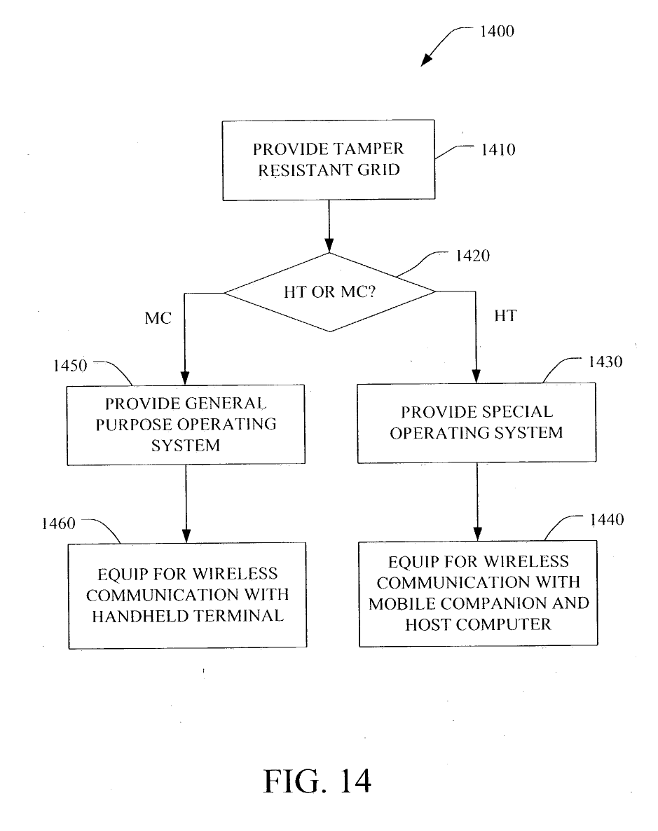

While, for purposes of simplicity of explanation, the methodology of FIG. 14 is shown and described herein as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

Turning now to FIG. 14, a methodology 1400 for fabricating a portable electronic device is depicted. The methodology begins at 1410 where a tamper resistant grid is provided to facilitate secure payment transactions. At 1420, it is determined whether the portable electronic device will be a handheld terminal or a mobile companion. If the portable electronic device is a handheld terminal, a general purpose operating system is provided at 1430. At 1440, the handheld terminal is equipped for wireless communication with a mobile companion and a host computer. However, if the portable electronic device is a mobile companion, it is provided with a special operating system at 1450. The mobile terminal is equipped for wireless communication with the handheld terminal, and optionally, the host computer, at 1460.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A two part payment terminal system comprising:
a handheld terminal employed to provide customer services; and
a plurality of mobile companions wirelessly associated with the handheld terminal, the mobile companions employed to process customer payments.

2. The system of claim 1, wherein the handheld terminal includes a docking station for one or more mobile companions.

3. The system of claim 2, wherein when a mobile companion is docked in a handheld terminal, the mobile companion can function as an integral part of the handheld terminal.

4. The system of claim 1, wherein the plurality of mobile companions can extract charge from the handheld terminal.

5. The system of claim 4, wherein the plurality of mobile companions can extract charge using inductive or direct contact based mechanisms.

6. The system of claim 1, further comprising an inductive charging basket to charge a plurality of mobile companions.

7. The system of claim 1, wherein the plurality of mobile companions includes a scanner to read printed receipts.

8. The system of claim 1, wherein the plurality of mobile companions employ inertial movement to read printed receipts.

9. The system of claim 1, wherein the plurality of mobile companions are pen-shaped.

10. The system of claim 1, wherein the handheld terminal includes a real time location tracking system.

11. The system of claim 10, wherein the real time location tracking system is based on triangulation.

12. The system of claim 10, wherein the real time location tracking system is based on a IEEE 802.11 WLAN signal.

13. The system of claim 10, wherein the real time location tracking system is based on radio frequency identification.

14. The system of claim 10, wherein the real time location tracking system is based on reading a bar code having location information encoded therein.

15. The system of claim 1, wherein the plurality of mobile companions include real time location tracking systems.

16. The system of claim 15, wherein the real time location tracking systems are based on triangulation.

17. The system of claim 15, wherein the real time location tracking system is based on triangulation.

18. The system of claim 15, wherein the real time location tracking systems are based on radio frequency identification.

19. The system of claim 15 wherein the real time location tracking systems are based on reading a bar code having location information encoded therein.

20. The system of claim 1, wherein the plurality of mobile companions are wirelessly associated with the handheld terminal via Bluetooth.

21. The system of claim 1, wherein the plurality of mobile companions are wirelessly associated with the handheld terminal via IEEE 802.11.

22. The system of claim 1, wherein the plurality of immobile companions are wirelessly associated with the handheld terminal via RFID.

23. The system of claim 1, wherein a customer can utilize a mobile companion to alert a server.

24. The system of claim 1, wherein the plurality of mobile terminals include smart card readers.

25. The system of claim 1, wherein the plurality of mobile terminals include a magnetic stripe reader.

26. The system of claim 1, wherein the handheld terminal includes a smart card reader.

27. The system of claim 1, wherein the handheld terminal includes a magnetic stripe reader.

28. The system of claim 1, further comprising an external printer.

29. The system of claim 1, wherein the handheld terminal includes a printer.

30. The system of claim 1, further comprising a security system to mitigate theft of at least one of the handheld terminal and the plurality of mobile companions.

31. A methodology for fabricating a portable electronic device comprising:
providing a tamper resistant grid; and
providing a general purpose operating system if the portable electronic device will be employed for receiving customer orders and providing a special operating system if the portable electronic device will be employed for processing customer payments.
